(19) United States
(12) Patent Application Publication
(10) Pub. No.: US 2012/0309273 A1
(43) Pub. Date: Dec. 6, 2012

(54) HAND-POWERED POLISHING APPARATUS AND KIT FOR STAINLESS STEEL SINKS

(76) Inventor: Georgi M. POPOV, Braselton, GA (US)

(21) Appl. No.: 13/153,872

(22) Filed: Jun. 6, 2011

(51) Int. Cl. B24D 15/00; B24B 1/00; C09K 3/14

(52) U.S. Cl. 451/57; 451/523; 51/307

(57) ABSTRACT

A manual scratch repair kit is provided for manually repairing scratches in stainless steel sinks and includes a handgrip having an underside with hook and loop fasteners and a sandpaper element attachable to the handgrip, the sandpaper element having an example grit of 800. Two soft pads are provided for holding and applying abrasive. Two containers of diamond abrasive compound of different grits are provided and the soft pads are color-keyed to the diamond abrasive compounds and/or the containers. The handgrip is sized to fit in the palm of the hand and preferably is relatively soft and pliable for comfort. While preferably the soft pads are color-keyed to the diamond abrasive compounds and/or the containers, other forms of optional identification can be employed as desired, such as printing a large “1” on the first pad and a corresponding “1” on the container of diamond abrasive compound. Optionally, the abrasive compounds are different colors and at least part of the soft pads are different colors and color-keyed to the different color compounds.

### TECHNICAL FIELD

The present invention relates generally to abrasives and in particular relates to a hand-powered apparatus/kit for polishing stainless steel sinks and the like.

### BACKGROUND

Stainless steel sinks and similar devices frequently suffer from being scratched or simply dulled over time. In the past, scratches have been removed by hand, by using traditional “rubbing compound” or sandpaper, widely available from a variety of sources. Such polishes often employ super-fine microscopic abrasive powder or ultra-fine abrasive minerals as a working abrasive. While such polishes and sandpaper are inexpensive to make and sell, the amount of manual effort required to address heavy scratches or dulled steel can be considerable.

As an alternative to polishing by hand, a machine can be used to polish with the same or similar polishes. Generally, a high-speed buffing machine is provided with a soft polishing pad (e.g., a soft foam or wool pad). A polish (abrasive compound) is applied to the pad and the machine is operated to polish the scratch and/or dullness, and to bring out the gloss in the metal finish. Unfortunately, such machines can be expensive, heavy, and difficult to use. Indeed, such machines can require considerable skill to avoid damaging or excessively abrading the steel finish (which can happen quickly). For these reasons, laypersons (non-experts) or consumers often shy away from using high-speed buffing machines.

Additionally, the typical remediation method for freshening up stainless steel items is to remove the item from its location, to polish it on a stationary buffing machine, and then to reinstall it. Such a method suffers from requiring that the item be removed and reinstalled. Also, many laypersons do not have access to a stationary buffing machine and/or are not adept at using them.

Accordingly, a need exists for a method and apparatus to remediate stainless steel sinks and similar items in a kitchen, the method and apparatus being suitable for use by non-experts. It is to the provision of such that the present invention is primarily directed.

### SUMMARY

Briefly described, the present invention comprises a hand-powered polishing kit/apparatus and related method for polishing stainless steel sinks and the like. In general, a highly effective (fairly aggressive) abrasive is used in hand polishing to give rapid results similar to a polishing machine, but with the control, cost, and simplicity of hand polishing. Advantageously, the abrasive includes a polishing paste made with diamond. The natural hardness of diamond makes it more abrasive than other minerals and has been found to be particularly suitable for use in hand polishing.

Compared to the fine dust in polishing compounds available today, diamond has one of the highest thermal conductivities at 900-2320 W/(m·K). This is contrasted with a thermal conductivity of only 120-180 W(m·K) for aluminum oxide for example, thus transferring heat created due to the friction between the work piece and the polishing disk/pad effectively. An additional advantage is the durability of the diamond cutting edges, which stay sharp for a very long time due to their superior mineral hardness. Moreover, the exceptional effectiveness of the diamond abrasive allows the user to treat deep scratches quickly and effectively

In a first example embodiment of the present invention, a manual scratch repair kit is provided for manually repairing scratches in stainless steel sinks. Preferably, the manual kit comprises a handgrip having an underside with hook and loop fasteners and a sandpaper element attachable to the handgrip, the sandpaper element having a grit of between 400 and 2000. Most preferably, the sandpaper element has a grit of about 800.

Two soft pads are provided for holding and applying abrasives, with each of the soft pads being made of soft natural felt material that allows the soft pads to be releasably mounted directly to the handgrip. Two containers of diamond abrasive compound of different grits are provided and the soft pads are color-keyed to the diamond abrasive compounds and/or the containers.

Preferably, the handgrip is sized to fit in the palm of the hand and preferably is relatively soft and pliable for comfort. While preferably the soft pads are color-keyed to the diamond abrasive compounds and/or the containers, other forms of optional identification can be employed as desired, such as printing a large “1” on the first pad and a corresponding “1” on the container of diamond abrasive compound. Optionally, the abrasive compounds are different colors and at least part of the soft pads are different colors and color-keyed to the different color compounds.

Optionally, the handgrip is at least partly dome-shaped. Preferably the soft pads are round, disk-like elements. Optionally, the soft pads comprise wool fiber pads or open cell foam pads.

In another preferred form, the present invention comprises a manual scratch repair method for manually repairing scratches in stainless steel sinks and the like. The manual scratch repair method comprises the steps of: (a) attaching a sand paper to a handgrip; (b) manually grinding the stainless steel sink by rubbing the metal with the sand paper using the handgrip; (c) removing the sand paper from the hand grip and replacing it with a first soft polishing pad; (d) applying an amount of a first diamond abrasive polishing paste to the first soft polishing pad; (e) manually polishing the stainless steel sink by rubbing the metal with the first soft polishing pad bearing the first diamond abrasive polishing paste; (f) removing the first soft pad from the hand grip and replacing it with a second soft polishing pad; (g) applying an amount of a second diamond abrasive paste to the second soft polishing pad, the second diamond abrasive paste having a finer grit than the first diamond abrasive paste; and (h) manually polishing the stainless steel sink by rubbing the metal with the second soft polishing pad bearing the second diamond abrasive polishing paste.

The back pad preferably should have a relatively soft surface, thus absorbing the diamond particles and holding them close to the surface to be polished. The surface should be soft, so that the diamond particles can penetrate into the pad when the pad is applied to the work piece. Such material softness can help to avoid unwanted scratching of the work piece surface with the diamonds in the diamond compound.

The specific techniques and structures employed to improve over the drawbacks of the prior devices and accomplish the advantages described herein will become more apparent from the following detailed description of example embodiments and the appended drawings and claims.

### BRIEF DESCRIPTION OF THE DRAWINGS

FIG. 1 is a bottom perspective view of a manual scratch repair kit according to a first example embodiment of the present invention, showing a handgrip, a set of sandpaper, a set of soft pads, and a set of containers of diamond abrasive compound.

FIG. 2 is a side cross section view of a first soft pad of the set of soft pads of FIG. 1.

FIG. 3 is a top perspective view of the handgrip and set of soft pads of FIG. 1.

FIG. 4 is a flowchart showing an example embodiment of the method of use of the present invention.

### DETAILED DESCRIPTION OF EXAMPLE EMBODIMENTS

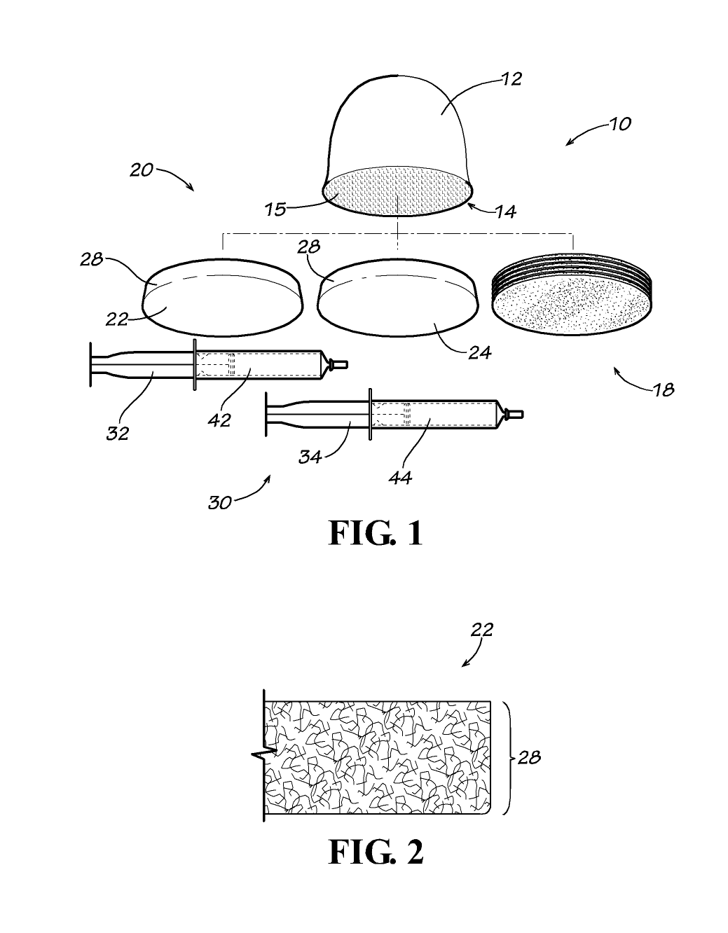

Generally described, the present invention relates to a manual scratch repair/polishing kit or apparatus for repairing and/or refinishing stainless steel, in particular for stainless steel sinks and kitchen appliances (like stainless steel refrigerators, stainless steel dishwashers, etc). FIG. 1 shows a manual scratch repair kit 10 according to a first example embodiment of the present invention. The repair kit 10 includes a hand grip 12, a set of sandpaper 18, a set of soft pads 20, and a set of containers 30 of diamond abrasive compound or paste.

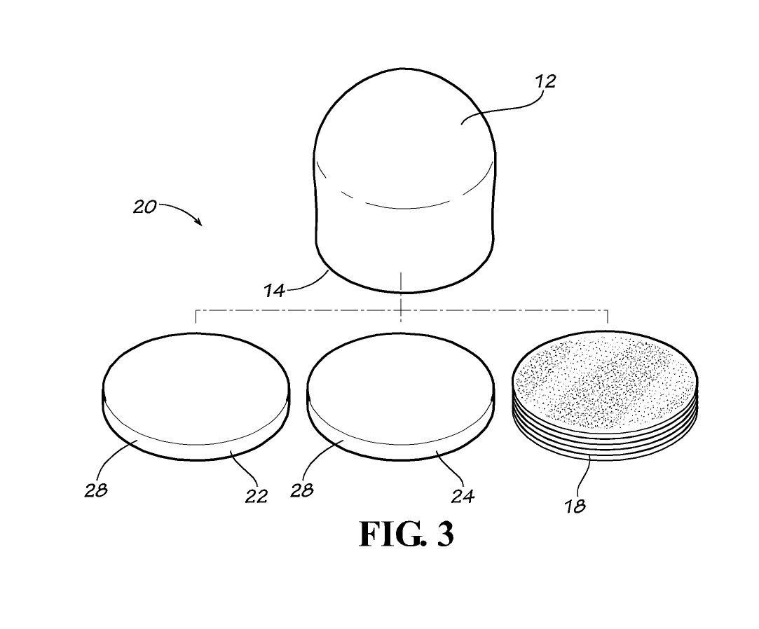

FIGS. 1 and 3 show the handgrip 12 in association with the set of soft pads 20. The handgrip 12 preferably is sized to fit in the palm of a user's hand and preferably is relatively soft and pliable for handling with comfort and ease. The handgrip 12 generally has a round and bulbous shape and preferably is partly dome-shaped. The middle portion helps the user hold the top of the handgrip 12 in the palm of his/her hand and rest his/her fingers on the middle portion. In other embodiments, the handgrip 12 can have any other shape that is designed to be ergonomic for use with the user's hand.

The handgrip 12 has a bottom portion or underside 14 that preferably is flat and planar, having hook and loop fasteners 15 attached thereon. Other types of fasteners, such as magnets, adhesives, etc., alternatively can be utilized on the bottom portion 14 of the handgrip 12. The handgrip 12 is pliable, both for comfort for the user and to allow the apparatus to conform somewhat to non-flat surfaces to be polished.

FIG. 1 shows the set of sand paper 18 and soft pads 20 in association with the handgrip 12. In this particular embodiment, the sets include the set or collection of sand paper 18, a first pad 22, and a second pad 24. Each soft pad is a disk-like element that comprises a disk-shaped body 28. The body 28 of the soft pads can be made from wool fibers, open cell foam, or any other suitable material. Alternatively, the top portion of the pad can comprise a layer of hook and loop material to complement the hook and loop material on the hand grip. However, generally speaking, such is not needed when using a soft felt pad. In use, the upper sides of the soft pads 22, 24 can be releasably mounted to the underside 14 of the handgrip 12 by the hook and loop fasteners. Preferably, the set of sand paper 18 comprises individual round sheets of sandpaper sized and shaped to fit the handgrip 12. Moreover, preferably the sand paper includes suitable hook and loop fastener material on the back thereof (or similar) for removable affixation to the face of the handgrip 12. Advantageously, the use of the handgrip to hold the sandpaper, rather than requiring the user to grip the sandpaper directly by hand, allows uniform and consistent pressure across the face of the sandpaper and prevents uneven sanding/grinding. Indeed, if one were to use one's fingers to engage the sandpaper, the sanding effect can be more or less striped, with regions directly under the fingers being abraded more substantially, while regions between the fingers are not abraded as much. The net effect of such hand sanding can be uneven, which is undesirable.

FIG. 1 shows the set of containers of diamond abrasive compound 30. As shown, the set includes a first container 32 and a second container 34. The containers are syringe-like dispensers, but in other embodiments, the containers can be tubs, tubes, jars, or other suitable types of containers. The containers each house a different diamond abrasive compound or paste therein. The first and second containers 32 and 34 house first and second diamond abrasive compounds 42 and 44 therein, respectively. The diamond abrasive compounds can be dispensed in controlled, small amounts to the soft pads by compressing the ends of the syringes and applying the tips of the syringes to the soft pads. In this regard, the syringes are preferred for their excellent control in dispensing rather small amounts, thus avoiding waste of the valuable diamond abrasive compounds.

The sandpaper used to prepare the surface for subsequent diamond polishing can have varying grit sizes, depending on the level of desired grinding and polishing. Generally, the sandpaper grit sizes are represented by a number, which designates the number of grits per square inch. Preferably, the sandpaper has a grit of 800×, but other grits can be used as desired. Generally speaking, grits of less than about 400× should be avoided, as the rougher, coarser finish left by such is harder to polish out. On the other hand, grits of greater than about 1500× are generally too fine to be used as an initial step in preparing the stainless steel for subsequent polishing with the diamond abrasives in that such fine grit sandpapers have a very slow cutting action. So generally, the sandpaper should have a grit size of between about 400× and 1500×. More preferably, the sandpaper should have a grit size of between about 600× and 1200×. Most preferably, the sandpaper can have a grit size of about 800×.

The diamond abrasive compounds can have varying grit sizes, depending on the level of desired grinding and polishing. Generally, the diamond grit sizes are represented by two numbers separated by a forward slash. The two numbers represent a range of values for the size of the diamond. The first number is generally the maximum value of the grit size range in microns, while the second number is generally the minimum value of the grit size range in microns as well. For example, a grit size of 14/10 would mean that the maximum value of the size of a diamond particle would be 14 microns, while the minimum value of the size of a diamond particle would be 10 microns. The diamonds in the abrasive compounds preferably have grit sizes selected from the group of 14/10, 10/7, 7/5, 5/3, 3/2, 2/1, and 1/0 or similar. It should be noted that the grit size 1/0 does not constitute a diamond with a minimum size value of 0 microns, but rather an average particle size of less than 0.5 micron, which would be mathematically rounded down to 0 microns.

Preferably, three different abrasive grits are used. For instance, in the example scratch repair kit 10, the first abrasive grit is in the sand paper with a preferred grit of 800 mesh size, which is sufficient in removing typical scratches found in stainless steel sinks without an undue amount of time and effort. A sand paper with a different mesh size can be used, depending on the severity and extent of the scratches. The next abrasive grit to be applied to the stainless steel surface is the first diamond abrasive compound 42 having a preferred grit size of 10/7. The next abrasive grit to be applied to the stainless steel surface is the second diamond abrasive compound 43 with a preferred grit size of 3/0. Different diamond abrasive compound grit sizes can be used if the sand paper has a mesh size other than 800. It is preferable that the grit sizes of the abrasives, including the diamond abrasive compounds, become finer as they are provided in succession.

Fewer or a greater number of different grit compounds can be employed. For example, two grits could be used or even a single grit compound could be provided. But it is preferred that a plurality of different compounds be utilized to provide a progressive polishing action and three different grit sizes (one sandpaper and two diamond abrasives) is believed to provide the best balance of cost and effectiveness. By using a progressive polishing action with three different grits, the polishing action is rapid, easy, and effective, while avoiding undue expense.

The soft pads preferably are color-keyed or color-coded to the containers of diamond abrasive compounds and/or the diamond abrasive compounds. Other forms of cross referencing identification, such as identifying characters, numerals, or letters, can be used as well. In the example embodiment of the scratch removal kit 10, the first soft pad 22, the first container 32, and the first diamond compound 42 are all color-keyed with the color orange. The second soft pad 24, the second container 34, and the second diamond compound 44 are all color keyed with the color grey. In other embodiments, any other colors or indicia can be used to color-key the soft pads to the containers and/or the diamond compounds. The color keying allows the user to follow a progressively finer polishing “script” to progressively polish the finish or metal without making mistakes. It also helps to avoid accidentally contaminating a fine grit pad with a coarse grit compound.

In use, the sand paper is releasably mounted to the bottom side of the handgrip. The user then manually grinds a stainless steel surface with the sand paper, using the handgrip 12. After sufficiently grinding the surface to remove scratches and/or other defects, the sand paper can be removed from the handgrip 12 and be replaced by the first soft pad 22. A small amount of the first diamond abrasive compound 42 is then dispensed or applied to the first soft pad 22. The user would then manually polish a surface with the soft pad 22 and the first diamond abrasive 42 thereon, using the handgrip 12. After sufficiently polishing the surface, the first pad 22 can be removed from the handgrip 12 and be replaced by the second soft pad 24. A small amount of the second diamond abrasive compound 44 is then dispensed on the second soft pad 24 and the second soft pad 24 is used to manually polish the surface. While the above example details using a single grit sandpaper, those skilled in the art will appreciate that the 800× sandpaper could be augmented with a second grit sandpaper, such as a 1200× sandpaper. Thus, prior to polishing with the diamond abrasive compounds, the stainless steel surface can be prepared with progressively finer sandpapers.

Mainly stainless steel sinks can be polished and/or buffed by the kit 10. The kit 10 allows the user to polish and buff a surface while getting feedback from the surface as to the status of the polishing and/or buffing. The kit 10 also allows the user to work at his or her own pace, and not be forced to worry about using a high speed buffing machine, which can be challenging and difficult to new users, as well as potentially damaging to surfaces. This provides the user with the confidence to use the kit without fear of doing major damage to the surface.

In and during use, the diamonds in the diamond abrasive compounds become embedded within the soft pads on which they are dispensed. This is advantageous because when the soft pads absorb the diamonds in the compounds, the diamonds can be held close to the surface of the pads and adjacent the surface they are polishing. The soft pads are generally made from a soft material, allowing the diamonds to penetrate therein when the pads are applied upon a surface and avoiding gouging the surface to be polished.

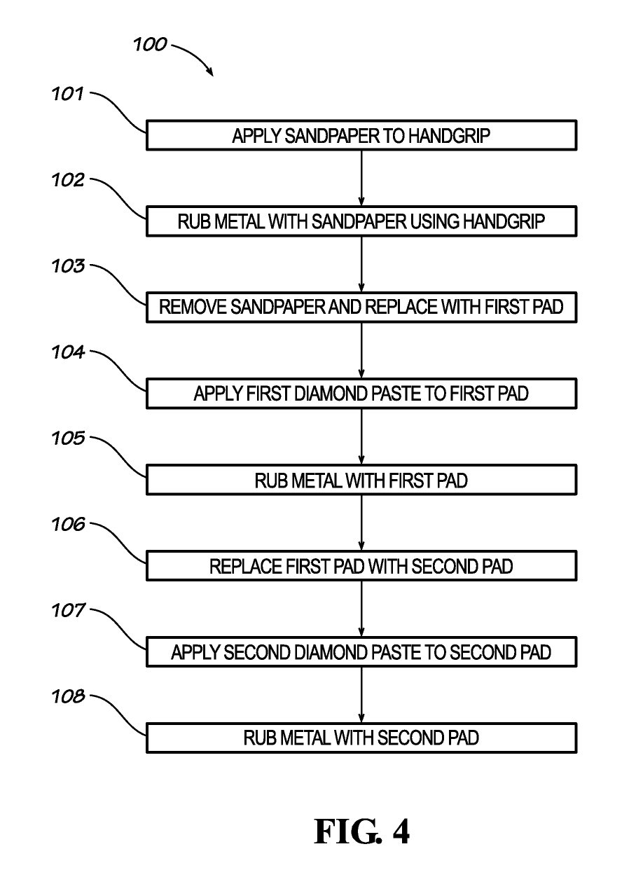

As shown in FIG. 4, a method 100 according to the invention can comprise a manual polishing method for manually polishing stainless steel sinks and the like. Preferably, as seen in FIG. 4 the method can comprise the steps of: (101) applying or attaching a sand paper to a handgrip, (102) manually grinding the stainless steel sink by rubbing the metal with the sand paper using the handgrip; (103) removing the sand paper from the hand grip and replacing it with the first soft polishing pad; (104) applying an amount of a first diamond abrasive polishing paste to the first soft polishing pad; (105) manually polishing the stainless steel sink by rubbing the metal with the first soft polishing pad bearing the first diamond abrasive polishing paste; (106) removing the first soft pad from the hand grip and replacing it with a second soft polishing pad; (107) applying an amount of a second diamond abrasive paste to the second soft polishing pad, the second diamond abrasive paste having a finer grit than the first diamond abrasive paste; and (108) manually polishing the stainless steel sink by rubbing the metal with the second soft polishing pad bearing the second diamond abrasive polishing paste. This polishing method can be accomplished in situ.

Although a two diamond abrasive paste kit and method is preferred, optionally, the manual polishing method just described above can further comprise the steps of: removing the second soft pad from the hand grip and replacing it with a third soft polishing pad; applying an amount of a third diamond abrasive paste to the third soft polishing pad, the third diamond abrasive paste having a finer grit than the second diamond abrasive paste; and manually polishing the stainless steel by rubbing the surface with the third soft polishing pad bearing the third diamond abrasive polishing paste.

It should be noted that in other embodiments of the present invention, the number of soft pads and containers with diamond abrasive compound therein can differ from the first example embodiment. In other embodiments, the amount of soft pads and containers with diamond abrasive compounds provided can be three, four, five, etc. Additionally, the method of using such soft pads and containers with diamond abrasive compounds can be changed accordingly in order to accommodate the amount of soft pads and containers.

It is to be understood that this invention is not limited to the specific devices, methods, conditions, or parameters of the example embodiments described and/or shown herein, and that the terminology used herein is for the purpose of describing particular embodiments by way of example only. Thus, the terminology is intended to be broadly construed and is not intended to be unnecessarily limiting of the claimed invention. For example, as used in the specification including the appended claims, the singular forms “a,” “an,” and “the” include the plural, the term “or” means “and/or,” and reference to a particular numerical value includes at least that particular value, unless the context clearly dictates otherwise. In addition, any methods described herein are not intended to be limited to the sequence of steps described but can be carried out in other sequences, unless expressly stated otherwise herein.

While the claimed invention has been shown and described in example forms, it will be apparent to those skilled in the art that many modifications, additions, and deletions can be made therein without departing from the spirit and scope of the invention as defined by the following claims.

1. A manual scratch repair/polishing kit for manually repairing scratches and/or polishing stainless steel sinks, the manual kit comprising:
a handgrip having an underside with hook and loop fasteners;
a sandpaper element attachable to the handgrip, the sandpaper element having a grit of between 400 and 2000;
two soft pads for holding and applying abrasive, each of the soft pads comprising felt to allow the soft pads to be releasably mounted to the handgrip;
two containers of diamond abrasive compound of different grits; and
wherein the soft pads are color-keyed to the diamond abrasive compounds and/or the containers.

2. A manual scratch repair/polishing kit as claimed in claim 1 wherein the abrasive compounds are different colors and at least part of the soft pads are different colors and color-keyed to the different color abrasive compounds.

3. A manual scratch repair/polishing kit as claimed in claim 2 wherein a portion of each of the soft pads is generally the same color as the abrasive compounds.

4. A manual scratch repair/polishing kit as claimed in claim 1 wherein the sandpaper element has a grit size of between about 600 and 1000.

5. A manual scratch repair/polishing kit as claimed in claim 1 wherein the sandpaper element has a grit size of between about 700 and 900.

6. A manual scratch repair/polishing kit as claimed in claim 1 wherein the handgrip is pliable.

7. A manual scratch repair/polishing kit as claimed in claim 6 wherein the handgrip is at least partly dome-shaped.

8. A manual scratch repair/polishing kit as claimed in claim 1 wherein the soft pads are round, disk-like elements.

9. A manual scratch repair/polishing kit as claimed in claim 8 wherein the soft pads comprise wool fiber pads.

10. A manual scratch repair/polishing kit as claimed in claim 8 wherein the soft pads comprise open cell foam.

11. A manual scratch repair/polishing kit as claimed in claim 1 wherein the containers comprise syringe-like dispensers for dispensing controlled, small amounts of the diamond abrasive compound.

12. A manual scratch repair/polishing kit as claimed in claim 1 wherein the first diamond abrasive compound has a grit size of about 10/7, and the second diamond abrasive compound has a grit size of about 3/0.

13. A manual scratch repair/polishing kit as claimed in claim 1 wherein the soft pads comprise natural soft felt.

14. A method of manually polishing a stainless steel sink in situ comprises the steps of:
a. attaching a sand paper to a handgrip;
b. manually grinding the stainless steel sink by rubbing the metal with the sand paper using the handgrip;
c. removing the sand paper from the hand grip and replacing it with a first soft polishing pad;
d. applying an amount of a first diamond abrasive polishing paste to the first soft polishing pad;
e. manually polishing the stainless steel sink by rubbing the metal with the first soft polishing pad bearing the first diamond abrasive polishing paste;
f. removing the first soft pad from the hand grip and replacing it with a second soft polishing pad;
g. applying an amount of a second diamond abrasive paste to the second soft polishing pad, the second diamond abrasive paste having a finer grit than the first diamond abrasive paste; and
h. manually polishing the stainless steel sink by rubbing the metal with the second soft polishing pad bearing the second diamond abrasive polishing paste.
